(19) United States
(12) Patent Application Publication
(10) Pub. No.: US 2015/0271086 A1
(43) Pub. Date: Sep. 24, 2015

(54) Reducing Network Traffic By Intercepting Address Resolution Messages

(71) Applicant: Rajant Corporation, Malvern, PA (US)

(72) Inventors: Paul Hellhake, Downingtown, PA (US); David Acker, Malvern, PA (US); Joe Parks, Coatesville, PA (US)

(73) Assignee: Rajant Corporation, Malvern, PA (US)

(21) Appl. No.: 14/223,397

(22) Filed: Mar. 24, 2014

(51) Int. Cl. H04L 12/823; H04L 12/841; H04W 28/02; H04L 12/859

(52) U.S. Cl. CPC H04L 47/323; H04L 47/2475; H04L 47/28; H04W 28/0289

(57) ABSTRACT

Networks based on Internet Protocol (IPv4) employ an administrative Address Resolution Protocol (ARP) to convert logical IP addresses into physical Ethernet media access control (MAC) addresses. These queries address the entire network, and in very large networks, they contribute substantially to network traffic. This invention identifies ARP packets in a large, dynamic network and uses various means to minimize their broadcast throughout the network. This results in optimized network performance.

### BACKGROUND

The methods and apparatus disclosed concern communication over networks. An example is provided based on the Internet Protocol Version Four (IPv4), and specifically, an IPv4 networking running the Address Resolution Protocol (ARP) in order to maintain physical (Ethernet MAC) address to IPv4 address tables.

The Internet Protocol and Address Resolution Protocol are well established industry standards. ARP is used in a standard IPv4 network as the translation between OSI Layer 3 (Network) using IP addressing and OSI Layer 2 (Data-Link) using Media Access Controller (MAC) addresses.

FIG. 1 illustrates the Address Resolution Protocol 100. The process starts at step 102 where a source device has an IP address, and needs a physical address translation. At step 104, if the physical address is found in the ARP cache of the source device, the physical address is returned from the cache and the process is complete at step 128. If the required address is not in the ARP cache of the source device, an ARP request is created at step 106. If it is determined at step 108 that the IP address was recently dropped from the ARP cache because the cache entry had passed an expiry timeout, at step 110, the cache entry may still be correct, but is not trusted. In that case, a unicast to the MAC address shown in the time-expired cache entry is first attempted. If a reply to the unicast is received in step 112, the ARP response is processed in step 124, the ARP cache is updated in step 126, and the process completes at step 128. If the address was not identified in step 108 among recently expired addresses recently dropped from the cache, or if the unicast response times out without a reply at step 114, the ARP request is broadcast to the network at step 116.

If no response is received to the broadcast in step 118, the source device times out in step 120, and concludes in step 122 that the intended destination device is not on the network. The process then finishes at step 128.

When the intended destination is reached by an ARP request packet, either a unicast packet from step 110 or a broadcast packet from step 116, the destination processes the ARP request in step 140, generates an ARP reply in step 142, updates its own ARP cache with information for the source device (extracted from the request packet), and sends an ARP reply directly to the source in step 146. That packet is received at the source in step 118, processed at the source in step 124, the source updates its cache in step 126, and the process completes 128.

Where the source device finds a valid destination MAC address in its cache in step 104, or receives an updated MAC address in step 112 or 118, then step 128 may be followed by substantive communication between the source and destination devices.

ARP caches are very widely used on IP networked devices. Both client and switch/router devices routinely cache ARP data. However, caching ARP data alone does not solve the problem of efficiently dealing with a dynamic network, because the cache rapidly becomes incomplete or outdated. When ARP is implemented in a large network with many moving parts and peripheral hardware, broadcast request messages are transmitted to many or all of the constituent parts of the network almost constantly, using up considerable resources for messages that are often redundant and unnecessary. In addition, simple caching does not exploit the information already known in a network to allow one node's knowledge of the network to answer another node's ARP request.

In a variant known as “proxy ARP,” a proxy device stops an ARP request directed to a destination device beyond the proxy device. The proxy device then offers its own address to the source device as the answer to the ARP request. The responding proxy device then receives traffic from the source device and routes the traffic to the proper destination device. This approach is often used by IP gateways to route traffic from one IP subnet to another without the users in the source subnet having knowledge of the destination subnet. If the proxy device fails, the source device will continue to direct traffic to the proxy ARP until the source device's ARP cache times out. Also, administrators on one subnet will not be able to see the MAC addresses in use on the other side of a proxy ARP device. Proxy ARP systems that do not have an answer to the original request usually do not use a “backing off” algorithm to control the flow of ARP request messages on the destination subnet. In fact, these systems often resend all of their unanswered ARP requests in massive bursts with no rate limiting or flow control.

There is therefore still a need for a more efficient way of disseminating ARP data within a network, especially a complex and dynamically changing network.

### SUMMARY OF THE DISCLOSURE

The present specification concerns reducing repetitive multiples of administrative data traffic and overhead data in communications networks. The ARP intercept protocol identifies ARP packets in a dynamic network and reduces the occurrence of retransmission and broadcast of messages throughout the network by means of an algorithm embedded in network fabric devices, such as routers or switches. When the ARP packet is determined to be unnecessary, it is not forwarded. Additionally, when the network knows that a hardware component for which an ARP request is being broadcast is no longer part of the network, the network dismisses the ARP request message. The ARP intercept protocol can vastly reduce congestion, traffic, and unneeded messages in a data network, thus freeing valuable network resources and bandwidth, reducing congestion, and improving transmission of useful traffic.

One embodiment of a method of managing traffic on a network comprises receiving at an intercepting node device of the network a broadcast address resolution request from a source device directed to a logical address of a destination device other than the intercepting node device, where the intercepting node device has a current cached physical address matched to the logical address of the destination device, sending to the source device an address resolution reply providing the physical address of the destination device, and not further broadcasting the address resolution request, and where the intercepting node device does not have a cached physical address of the destination device, further broadcasting the address resolution request.

A cached physical address may be treated as current if it was acquired by the intercepting node device more recently than a timeout limit.

Where the intercepting node device has a physical address of the destination device that is not current, the intercepting node may unicast the address resolution request to that physical address of the destination device.

A cached physical address may be treated as current if it was acquired by the intercepting node device more recently than a first timeout limit, and may be deleted from the cache if it was acquired by the intercepting node device less recently than a second timeout limit longer than the first timeout limit.

An address resolution request may be dropped, and not further broadcast, if the intercepting node device further broadcast an earlier address resolution request for the same destination device more recently than a time limit.

When an address resolution message is received at the intercepting node device, the intercepting node device may update a cache of the intercepting node device with the physical address from the address resolution message.

The logical address may be an Internet Protocol (IP) address, the physical address may be a Media Access Controller (MAC) address, and the address resolution request and reply may be an Address Resolution Protocol (ARP) request and reply.

An embodiment of a device is operative to act as a node forwarding messages in a network, and which is an intercepting node device programmed to carry out any of the methods mentioned above.

An embodiment of a network includes at least one intercepting node device as mentioned above.

The network may be a radio mesh network.

The network may comprise nodes to which external devices attach, and at least all nodes to which external devices attach may then be intercepting node devices programmed to carry out any of the above-mentioned methods.

At least one node of the network may be operative to carry out the above-mentioned method only in respect of address resolution requests for which the “intercepting” node device is itself the source device.

An embodiment of a non-transitory computer readable storage medium contains instructions to cause a network node device to carry out any of the above-mentioned methods.

ARP Intercept is not confined to use as part of an IP gateway, and the changes to ARP packets (answering packets, or converting broadcast to unicast) can be totally transparent to the users of the network. The failure of a device implementing ARP Intercept will not affect traffic flow. The sender has the correct MAC address for the real destination device, not the address of the intercepting device, and can continue to send traffic to that destination MAC address. Administrators throughout the network can see all the true MAC addresses in use, because ARP Intercept sends ARP replies that provide the correct MAC address that the intercepting device learned earlier. Meanwhile, ARP Intercept implements a backing off protocol that prevents the overflow of ARPs for devices that are rarely, if ever, on the network.

### BRIEF DESCRIPTION OF THE DRAWINGS

The above and other aspects, features, and advantages of the disclosed embodiments may be more apparent from the following more particular description of embodiments thereof, presented in conjunction with the following drawings. In the drawings:

FIG. 1 is a flowchart of implementation of the Address Resolution Protocol (ARP).

FIG. 2 is a flowchart of implementation of an ARP Intercept Protocol in an intercepting device.

FIG. 3 is a diagram of a mesh network running the ARP Intercept Protocol of FIG. 2 at the mesh's boundary nodes.

FIG. 4 is a diagram of a typical mesh network node computer.

### DETAILED DESCRIPTION OF THE ILLUSTRATED EMBODIMENTS

A better understanding of various features and advantages of the present methods and devices may be obtained by reference to the following detailed description of illustrative embodiments and accompanying drawings. Although these drawings depict embodiments of the contemplated methods and devices, they should not be construed as foreclosing alternative or equivalent embodiments apparent to those of ordinary skill in the subject art.

When the Address Resolution Protocol (ARP) is implemented in a large network with many moving parts and much peripheral hardware, broadcast ARP request messages are transmitted to many or all of the constituent parts of the network almost constantly, using up considerable resources for messages that are often redundant and unnecessary. This is especially problematic where the network is a radio mesh network. Some radio mesh networks are capable of supporting hundreds of nodes. Mobile radio mesh networks tend to be highly mobile and volatile, with nodes constantly moving and dropping on and off the network. ARP itself was not designed to cope with such a rapidly changing network. In addition, the information requested by ARP requests is often already known to the mesh itself as part of the mechanics of the mesh, so the ARP traffic itself is often highly redundant. ARP traffic can severely diminish the throughput of such a network.

A major problem with ARP in a large system is the need to broadcast request packets to resolve a physical address. In a small network, ARP is not seen to be all that much overhead. A 6 node system could update each device's ARP cache with a total of 15 broadcast packets and 15 unicast replies, because each ARP request and reply updates both the source and destination caches. In general, for a network of N nodes, the number of broadcast request packets needed for a full update is (N−1)*(N/2) packets. That means that the ARP traffic increases very rapidly as the number of nodes increases. For example, if there are 500 nodes, there will be 124,750 request packets to broadcast, and 124,750 directly addressed replies, for a full update.

This traffic is bad enough on a wired network, but much worse on wireless networks, such as a highly mobile mesh network. Modern wired networks are inherently a system of nodes and switches, so while there will be some interference, node-to-node, as traffic increases, there are usually multiple parallel paths between nodes. In a wireless system, there is only one medium, so only one message at a time can be broadcast on each frequency. Also, the number of available frequencies is limited. If one radio is broadcasting, all others in range must remain quiet on that frequency. A relatively small number of packet broadcasts—which each radio in turn must relay—can adversely affect the performance of a mesh radio network.

The ARP Intercept Protocol identifies ARP packets in a dynamic network and reduces the occurrence of retransmission and broadcast of messages throughout the network by means of an algorithm embedded in network fabric devices, such as routers or switches. When the ARP packet is determined to be unnecessary, it is not forwarded. Additionally, when the network knows that a hardware component is no longer part of the network, it dismisses the ARP message. The ARP intercept protocol vastly reduces congestion, traffic and unneeded messages in a data network thus freeing valuable network resources and bandwidth.

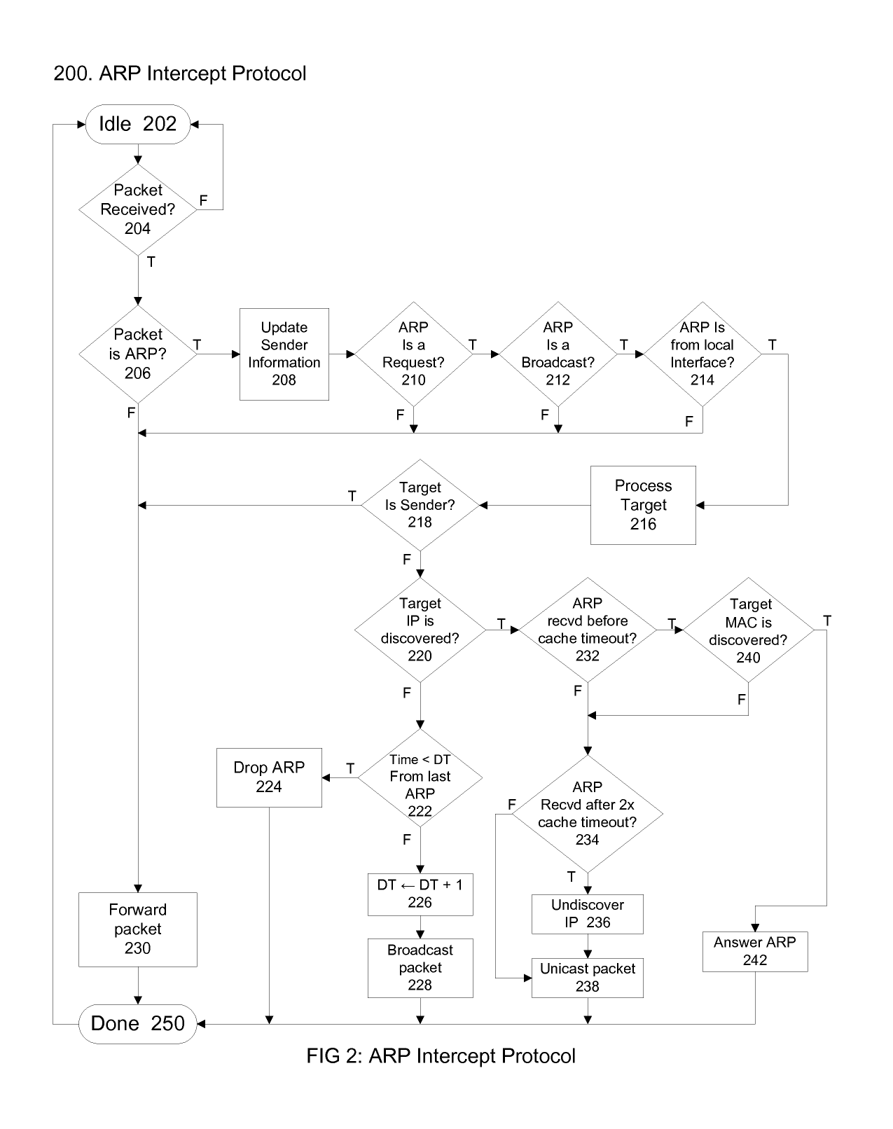

Referring now to FIG. 2, one embodiment of the ARP Intercept Protocol 200 runs as a packet filter on every mesh radio in a network. In the interests of simplicity, the processing is described as it is done on a single node. Preferably, however, the same protocol is running on nodes throughout the network.

In the ARP Intercept Protocol 200 shown in FIG. 2, when no packet is received, the process is idle, shown in FIG. 2 as a loop between the IDLE state of step 202 and step 204 returning “packet received=FALSE.” In step 204, a packet enters the process as it would enter any other packet filter. When a packet is received, the packet is checked in step 206 to see whether it is an ARP packet. If the packet is not an ARP packet, that packet is processed in the usual way, shown in FIG. 2 as forwarding the packet in step 230, and the process ends in step 250.

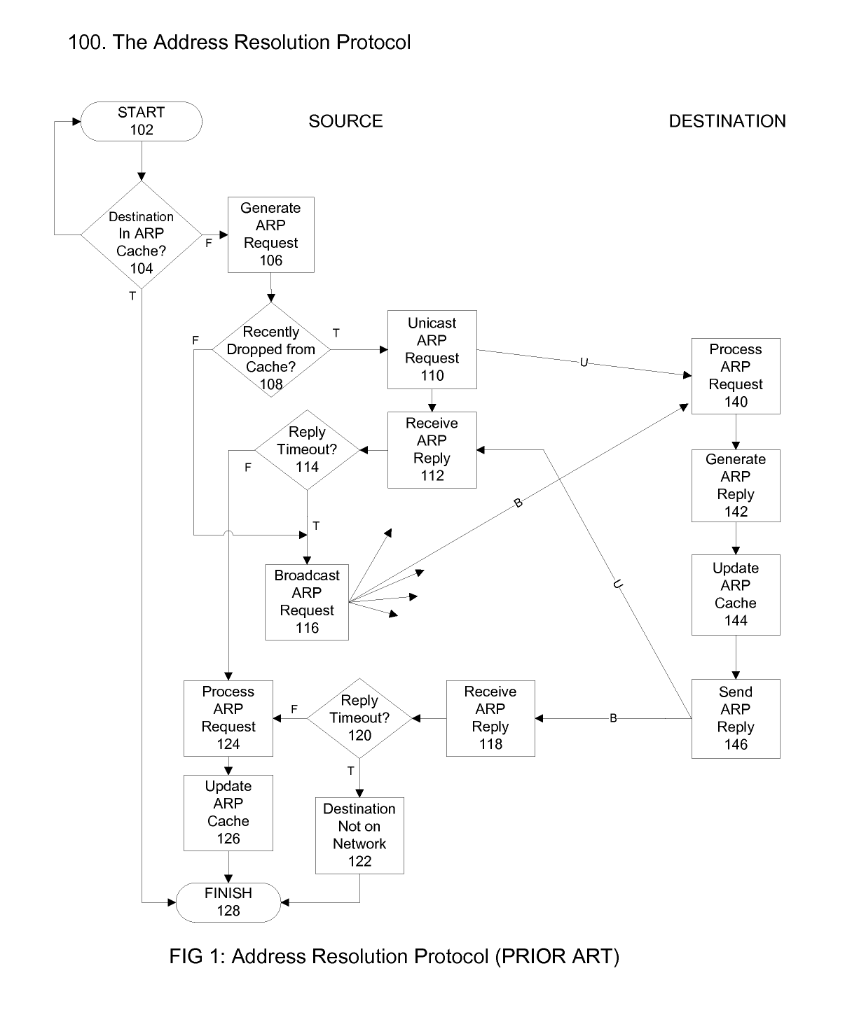

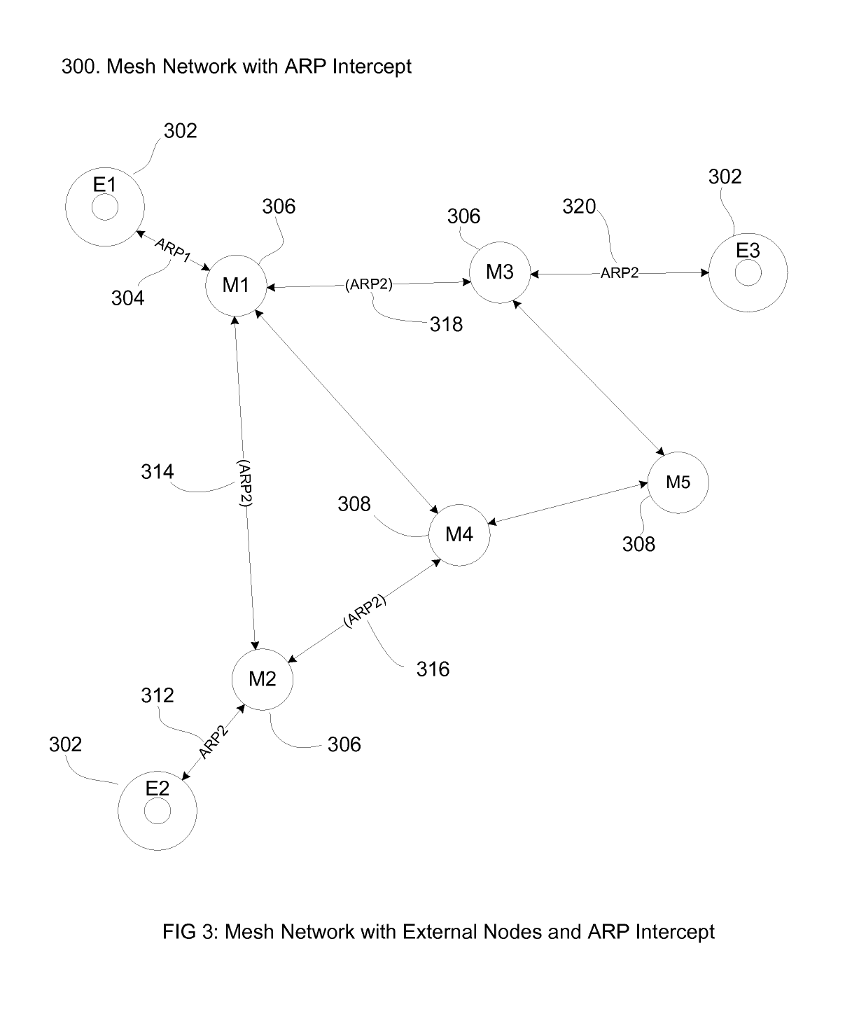

If the packet is an ARP packet, in step 208 the intercepting device updates its own local ARP cache with the sender information. Then the packet is further examined. If this is not an ARP request packet, step 210, the packet is forwarded or otherwise processed in step 230, and the process ends in step 250. If this not a broadcast, step 212, the packet is forwarded in step 230. A unicast packet, see step 110, is much less burdensome to the network, so there is less need to intercept it. If this packet is not from one of the local network connections, step 214, the packet is forwarded or otherwise processed in step 230, and the process ends in step 250. As will be described below with reference to FIG. 3, in this embodiment the ARP Intercept Protocol 200 is applied at step 214 only if the ARP request broadcast packet originates from the intercepting node itself or from an immediately adjacent node. If the broadcast originates from a more distant source, it is reasonable to assume that an intervening node would already have applied the ARP Intercept Protocol if applicable. If the source node is the intercepting node, then the ARP Intercept Protocol can replace the relevant parts of the conventional source process described in FIG. 1.

In any event, if the packet is any sort of an ARP packet, the intercepting node may create or update its cache entry for the source node with the IP address and MAC address for the source node extracted from its packet.

If the packet is an ARP broadcast request from a local network interface from step 116 (see FIG. 1), then starting at step 216 the packet is now further examined.

If the packet's target IP address is the same as the sender's IP address (step 218), the packet will once again be forwarded at step 230 and the process ends at step 250. It is accepted procedure for a device to broadcast ARP requests for its own IP address to see if any other device claims to be using the same address. Such broadcasts are important to prevent or eliminate instances of two devices using the same IP address. If these packets were not forwarded, the original sender would be prevented both from finding out if anyone else is using the address, and from alerting the other user to the conflict.

After step 218=FALSE, the packet is known to be for a different target. If the target IP address is not known (step 220), the time since the intercepting node last saw an ARP request for the same destination address is checked at step 222. If the time is less than an internal timer count limit DT for that destination address, the protocol drops the ARP request at step 224. There is no need to pass on an ARP this soon, because the probability that the destination node has been added to the network in the meantime is low. If the elapsed time from the last ARP request is greater than DT, the process increments the count limit DT at step 226 and broadcasts the packet at step 228. If the destination node is repeatedly not detected, then there is an increasing probability that the node is seldom or never present on the network. Progressively increasing the count limit DT between successive broadcasts for such a node reduces the traffic capacity wasted on broadcasts that are likely to be futile because the destination node is still not there. A cache entry containing the destination IP address without an MAC address (for example, with a blank MAC address or the broadcast address FF:FF:FF:FF:FF:FF) may be set up for use in step 222. A proper MAC address can then be added to the cache entry as soon as it is received.

If at step 220 the intercepting node executing the process knows the target IP address and has a cached MAC address, at step 232 the process checks whether the ARP request was received before or after the ARP cache timeout. The cache timeout is typically of fixed length for the whole cache, for practical reasons, but runs separately for each entry from the time that entry was last updated or verified. If the ARP request has been received before the cache timeout, then at step 240 a check is made to see if the physical location for the target MAC address was discovered. The intercepting node should acquire the destination device location when the MAC address is acquired, but in a wireless network in which nodes can move easily, the intercepting node may become aware that the destination device's physical location is no longer correct, and delete it without being able to update it, even if the MAC address is still valid on the network.

If the intercepting local device has a cached MAC address for the target, including a physical location, that has not timed out, the local device can answer that ARP request locally. Therefore, in step 242, the intercepting node sends back to the source node an ARP reply message providing the MAC address of the original target node. The ARP reply message is formatted so that the source node can receive and process the ARP reply message in step 110 exactly as if the ARP reply message had originated from the target node in step 126, and may be a plausible imitation of the ARP reply message that the target node would have sent. Thus, the process can be transparent in the sense that the original source node does not know that the intercepting node was involved. In contrast to step 228, the intercepting node at step 242 does not further broadcast the ARP request, and thus avoids burdening the rest of the network with the broadcast. The process is then complete at step 250.

When the intercepting device has a cached IP address and MAC address for the target, but the ARP request was received after the cache timeout (step 232), another check is made in step 234. If the ARP request was received after a second timeout, which in this embodiment is two times the cache timeout used in step 232, the protocol “undiscovers” the MAC address, and deletes it from the cache in step 236. The IP address is retained in the cache, so that timing data can continue to be tracked.

When the age of the cached IP address is between the cache timeout and the second timeout, at step 238 the intercepting device unicasts the ARP request packet to the target IP address, and completes the process at step 250. Because only a unicast, and not a broadcast, is needed, the burden on the remainder of the network is reduced if this unicast succeeds. When the protocol deletes the cache entry in step 236, it makes one last attempt to reach the target address by unicast in step 238.

When the intercepting device has a cached IP address and MAC address for the target, but does not have the physical location of the target MAC address (step 240=False), at step 238 the intercepting device unicasts the ARP request packet to the target IP address, relying on other network protocols to resolve the MAC address into the physical network location, and completes the process at step 250.

In each of those cases, because only a unicast, and not a broadcast, is needed, the burden on the remainder of the network is reduced.

The process then goes to the Done state, step 250. If no response is received to the unicast packet sent in step 238, and it was after the second cache timeout (step 234=True), the IP address is undiscovered by step 236 on this pass through the process, and the next broadcast ARP request will go from step 220 to step 222. If no response is received to the unicast packet sent in step 238, the process continues to unicast the packet on subsequent retries from the source node until the second cache timeout. Sending the unicasts drives attempting to find the destination node, without imposing the burden of a full broadcast. The cache timeout, and especially the second cache timeout if that can be set independently of the first cache timeout, may be set taking into account, among other factors, of how long it is efficient to continue unicasting.

If no response is received to the unicast at step 238, the originating source node will receive no reply to its broadcast, and will itself in due course time out and retry.

Thus, the ARP Intercept process eliminates broadcast ARP requests for devices that it has recently heard ARP packets from and knows are on the network. The process converts broadcast ARP requests to far less burdensome unicast requests for devices that have been heard from less recently. Finally it greatly reduces broadcast ARP requests for devices that are rarely on the network by imposing a minimum time DT between successive ARP requests for the same undiscovered device. All of these techniques reduce excessive broadcasts while maintaining transparent compatibility with other devices on the network.

Referring now to FIG. 3, one embodiment of an active mesh network running the ARP intercept protocol 200 of FIG. 2 consists of five nodes. Three nodes 306 are boundary nodes, M1, M2, and M3; two nodes, M4 and M5, are mesh-only nodes. A boundary node by definition is communicating via traditional IPv4 and/or IPv6 protocols to external nodes 302. In this model, there are also three external nodes: E1, attached to mesh node M1; E2, attached to mesh node M2, and E3, attached to mesh node M3.

In this embodiment, the mesh itself does not use the IPv4 ARP protocol as a means of resolving IP addresses. The mesh operates at the Ethernet layer, layer 2. So ARP packets are not used within the mesh itself. The mesh can pass ARP packets through, and the external nodes 302 are using ARP to locate each other across the mesh. The mesh nodes also listen to ARP packets that they pass through, so as to learn the MAC addresses of the external nodes present on the network. Each boundary node 306 of the mesh is running the ARP Intercept Protocol 200, doing what it can to keep ARP messages out of the network. Other embodiments do use the ARP protocol, or similar level 3 protocols, internally.

In a first case, external node E1 sends an ARP request packet 304 (ARP1) in an effort to find external node E3. The mesh node 306 at M1 already has this translation in its ARP cache (step 240=True), and so node M1 provides the address translation response back to node E1, keeping the ARP out of the mesh. External node E1 receives the reply at step 118, and does not even know that the reply came from the cache at M1 in step 242, and not from target node E3 in step 146.

In a second case, node E1 sends the ARP request ARP1 to mesh node M1, which does not have the translation for node E3. However, the time is within the frame DT to drop the ARP packet, so the packet is just dropped. External node E1 then times out at FIG. 1 step 120=True.

Concurrently with this, external node E2 also sends an ARP packet 312 (ARP2) into the mesh at node M2, also looking for the address of external node E3. Node M2 has no knowledge of node E3, so it adds the IP address of node E3 to its cache without an MAC address, and broadcasts 314, 316 the ARP packet ARP2 in the mesh as packets 314, 316 to mesh nodes M4 and M1. Because ARP request packet 314 is coming from a node M2 within the mesh, in this embodiment M1 does not apply the ARP intercept protocol 200. Therefore, even if the packet 314 is still within the timeout frame DT that was applied to ARP request 304, M1 broadcasts ARP2 as packet 318 to mesh node M3, which knows external node E3, and can forward that packet 320 to node E3. External node E3 replies with a conventional unicast ARP reply packet, which follows back the same paths, via mesh nodes M3, M1, and M2 into external node E2.

While forwarding packet ARP2, node M1 reads the packet, and updates its own cache to show current information for external node E2. While forwarding the reply, node M1 reads the packet, and updates its own cache to show current information for external node E3.

At this point, the ARP packet 304 (ARP1) has timed out at source node E1 at FIG. 1, step 120, because it was dropped at FIG. 2 step 224 by intercepting node M1, rather than being replied to. After an appropriate time delay, external node E1 restarts the process of FIG. 1, and sends another ARP packet 304 to mesh node M1. Node M1, because it was a relay point for the ARP request and reply traveling from E2 to E3 and back to E2, now knows the current MAC addresses, locations, and best routes to both E2 and E3. So node M1 can now reply to node E1 directly from its address translation cache, FIG. 2, step 242, again sparing the network the burden of another ARP broadcast packet.

In the interests of simplicity, the additional copies of the broadcast packet ARP2 that are sent between M1 and M4, and via M5, are not described in detail. It is assumed that the shortest route from M2 to M3 is clearly via M1, and that the other packets are all at some point discarded as duplicative. They are merely an example of the sort of useless traffic that results from unnecessary broadcasting, and that the ARP Intercept Protocol 200 seeks to reduce.

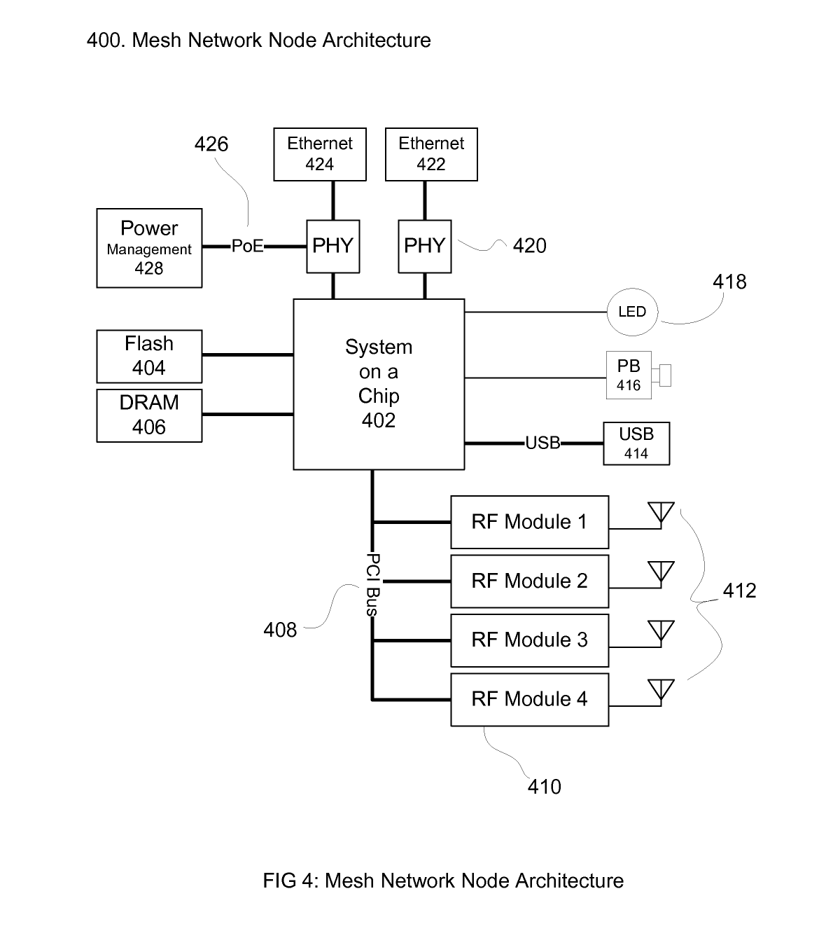

FIG. 4 illustrates a typical mesh routing radio 400, similar to the mesh radios supplied under the trademark BREADCRUMB by Rajant Corporation, Malvern, Pa. The radio is based around a network oriented computer system on a chip (SOC) 402, which contains the bulk of the functionality of the system. All computation, all routing, all support services occur on this device. The SOC 402 runs a bootloader that fetches program code and data from a flash memory 404 into random access memory (RAM) 406. The series of computer programs stored in that Flash memory 404 cover the complete operation of the mesh radio.

The SOC 402 implements a PCI Bus interface 408 that interfaces multiple radio frequency (RF) modules 410. Each RF module contains hardware that, together with the system software in the SOC, implements all network layers of the radio, access, and meshing protocols. Each RF module 410 hooks up to an appropriately tuned antenna 412; this has typically been one antenna per RF module, but newer modules offer multiple antenna options. The SOC also provides a USB port 414, for interface to external I/O devices such as memory and audio interface, and it provides general purpose I/O interface to control the node's only physical interface, a pushbutton switch 416 and a multi-color status LED 418.

The external network is attached via an Ethernet Physical media adapters 420 (PHY) and physical connectors 422, 424, sometimes an 8 position, 8 contact (8P8C) connector, sometimes a custom bulk connector. There is often one standard Ethernet port 422, and one Power-over-Ethernet (PoE) port 424, which allows the unit to be powered by a 24-48 V signal over the data cable. Power from the PoE interface 426 is routed to a power management subsystem 428, which generates the various voltages used in the system. Where the mesh routing radio 400 is used as a boundary node such as M1, M2, M3 in FIG. 3, the external nodes E1, E2, E3 may be connected to USB port 414, Ethernet port 422, or through antennae 412 and RF modules 410. The ARP intercept protocol 200 is most useful with wireless external nodes that attach to antennae 412, because wireless devices tend to be more mobile than wired devices. A mobile device may move from one mesh routing radio 400 to another, or may join or leave the network, very easily. Consequently, cached address data can become outdated quite quickly. Therefore, short cache expiry times, and a high rate of address discovery traffic, may be necessary.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The invention is therefore not limited by the above described embodiments, methods, and examples, but extends to all embodiments and methods within the scope and spirit of the disclosure.

For example, the embodiment shown in FIG. 2 is based on the Address Resolution Protocol in IPv4. Other embodiments can be used in other networking systems that implement a broadcast algorithm for locating devices on the network, including, for example, the Neighbor Discovery protocol in Internet Protocol Version 6 (IPv6).

In the interests of simplicity, the network shown in FIG. 3 has only 5 mesh nodes, 3 of which are boundary nodes. As mentioned above, the ARP Intercept Protocol 200 may be applied to nodes in larger meshes, and the benefits are greater in larger meshes, because the number of ARP broadcasts tends to increase roughly as the square of the number of nodes participating in the ARP traffic. In particular, if several external nodes E1, etc., attach to one boundary node N1, etc., then the cache of boundary node N1 becomes populated with all the other external nodes that any of its attached external nodes has discovered, in addition to nodes for which ARP packets have passed through node N1 between nodes N2 and N3. The external nodes E1, etc., attached to boundary node N1 are therefore effectively able to share all the ARP data that any of them have collected, in the single ARP Intercept cache on boundary node N1.

As shown in FIG. 2, all the external nodes E1, E2, E3 participate in ARP broadcasts, but the mesh nodes use a different protocol. Other configurations are possible.

If the mesh does not have distinct boundary and interior nodes, then all mesh nodes may be configured with the ARP Intercept Protocol 200. However, if (as described with reference to FIG. 2), the ARP Intercept Protocol is applied only to ARP packets received by the mesh node from an exterior node, then the ARP Intercept Protocol may be inactive on mesh nodes that for the time being do not have any external node attached to them. Alternatively, all nodes may be programmed with the ARP Intercept Protocol, and may use it to cache address resolution data for the node's own use, even if that node is in a location where it is not active to intercept ARP broadcasts from another node.

If distinct ports are used by a mesh node to attach to external nodes and to attach to other mesh nodes, then the ARP Intercept Protocol may be configured to operate only on incoming packets at ports to which external nodes attach.

Accordingly, reference should be made to the appended claims, rather than to the foregoing specification, as indicating the scope of the invention.

What is claimed is:

1. A method of managing traffic on a network, comprising:
receiving at an intercepting node device of the network a broadcast address resolution request from a source device directed to a logical address of a destination device other than the intercepting node device;
where the intercepting node device has a current cached physical address matched to the logical address of the destination device, sending to the source device an address resolution reply providing the physical address of the destination device, and not further broadcasting the address resolution request; and
where the intercepting node device does not have a cached physical address of the destination device, further broadcasting the address resolution request.

2. The method of claim 1, wherein a cached physical address is current if it was acquired by the intercepting node device more recently than a timeout limit.

3. The method of claim 1, further comprising, where the intercepting node device has a physical address of the destination device that is not current, unicasting the address resolution request to the destination device.

4. The method of claim 3, wherein a cached physical address is current if it was acquired by the intercepting node device more recently than a first timeout limit, further comprising deleting a cached physical address from the cache if it was acquired by the intercepting node device less recently than a second timeout limit longer than the first timeout limit.

5. The method of claim 1, further comprising not further broadcasting the address resolution request if the intercepting node device further broadcast an earlier address resolution request for the same destination device more recently than a time limit.

6. The method of claim 1, further comprising, when an address resolution message is received at the intercepting node device, updating a cache of the intercepting node device with the physical address from the address resolution message.

7. The method of claim 1, wherein the logical address is an Internet Protocol (IP) address, the physical address is a Media Access Controller (MAC) address, and the address resolution request and reply are an Address Resolution Protocol (ARP) request and reply.

8. A device operative to act as a node forwarding messages in a network, and which is an intercepting node device programmed to carry out the method of claim 1.

9. A network including at least one intercepting node device according to claim 8.

10. The network of claim 9, which is a radio mesh network.

11. A network that comprises nodes to which external devices attach, and wherein at least all nodes to which external devices attach are intercepting node devices programmed to carry out the method of claim 1.

12. The network according to claim 11, wherein at least one node is operative to carry out the method of claim 1 only in respect of address resolution requests for which said intercepting node device is also said source device.

13. A non-transitory computer readable storage medium containing instructions to cause a network node device to carry out the method of claim 1.
